(19) United States
(12) Patent Application Publication
(10) Pub. No.: US 2011/0285050 A1
(43) Pub. Date: Nov. 24, 2011

(54) Extrusion Process for Producing Plastic Granules Having a Statically Dissipative Effect

(76) Inventors: Clemens Grafe, Weimar (DE); Juan Carlos Caro, Weimar (DE)

(21) Appl. No.: 12/673,884

(22) PCT Filed: Aug. 14, 2008
(86) PCT No.: PCT/DE2008/050027

§ 371 Date: Jul. 20, 2011

(30) Foreign Application Priority Data
Aug. 17, 2007 (DE) 10 2007 039 380.8

(51) Int. Cl. B29B 9/06; B29B 9/12

(52) U.S. Cl. 264/143

(57) ABSTRACT

The invention relates to an extrusion process for producing plastic granules having a statically dissipative effect. The problem addressed by the invention is that of specifying a possible way of producing plastic granules which allows a thermo-plastic product having a maximum specific surface resistance of 10⁸Ω to be produced without using metal fibres, metal oxides, graphite, conductive carbon black, intrinsically conductive polymers, single-wall/multiwall carbon nanotubes, organically modified nanoclays or polyamide-polyether block amides (more precisely those based on adipic acid-caprolaetam polyether glycol copolymers and related substances), wherein the plastic granules are distinguished by improved dispersion of the active substances present therein. According to the invention, the problem is solved by means of an extrusion process for producing plastic granules, said process comprising the following steps:—in a preliminary stage, a mixture of lithium chloride and anticaking agents is ground to a particle size of d90=20 μm,—at least one organic, surface-active internal antistatic agent, a thermoplastic and the mixture are than provided in pure form, individually or as a mixture, and—fed to an extrusion machine simultaneously, successively or separately from one another.

The invention concerns an extrusion process for producing a plastic granulate having an effect of dissipating static.

Electrostatic charges are generated by friction between two contacting material surfaces that basically have different charge signs, due to electron transport operations.

For example, one of these material surfaces loses electrons and becomes positively charged, while the other accepts these electrons and becomes negatively charged.

The strength of this charge is dependent on the following factors:
degree of contact between the two surfaces,
friction properties of the materials,
atmospheric humidity, and
electrical properties of the plastics, for example the resistance and dielectric constant (a small value indicates a high tendency to build up a charge).

Due to the presence of electrically charged particles on the surface of plastic articles, problems can arise in transport, packaging and storage, if the resulting discharges arise in the vicinity of sensitive machines and devices. Moreover, if there is a sudden discharge of electrically charged particles, there is the danger of igniting explosive gas mixtures and the danger of failure of electronic life-maintaining devices like pacemakers in people who touch these machine parts.

Finally, the uncontrolled attraction of floating particles and dust affects the appearance, optics and function of thick- and thin-walled particles that are in continuous contact with streams of air.

The connection between dust attraction and high algae formation on unprotected plastic parts is well known. Algae diminish not only the visual appearance of the product, they also reduce the desired light transparency, as in the case of roofing made of double-wall panels. Algae also contribute to mechanical decomposition reactions. The result is that the lifespan of the product is shortened.

In general, the antistatic effect is determined by measuring the surface resistance (according to ASTM D257) or the volume resistance (according to DIN 53482) on one side, and the discharge time at the half-value of the applied voltage (according to DIN 53486E) on the other side.

A number of means have already proven themselves in minimizing the problems of electrostatic charges on plastics. The prior art includes both volume- and surface-active substances with different chemical background and thus different modes of action.

These available materials can be divided into:
(surface-active) cationic antistatics such as quaternary phosphonium and ammonium salts;
(surface-active) anionic antistatics such as alkyl sulfonates, alkyl phosphonates, alkyl thiocarbamates, chlorides, nitrates, hydrophosphates;
(surface-active) nonionic antistatics like ethoxylated and propoxylated long-chain alcohols, long-chain amines and fatty acid amides, polyethylene glycol esters or alkyl phenol esters of fatty acids, glyceryl monoesters and diesters and sorbitol esters of fatty acids;
(surface-active) organometal antistatics like alkyl titanates and alkyl zirconates;
(volume-active) conductive materials such as organically modified nanoclays, nanoscale metal oxides, carbon black (conductive black), graphite, nanotubes, metal powders and fibers of copper and aluminum, carbon fibers, metallized glass, intrinsically conductive polymers (for example polyacetals, polypyrroles, polythiophenes, polyanilines) and polyamide-polyether block amides.

Widespread, and also the cheapest and most effective variant, is the use of conductive black. One makes targeted use of the property of conductive black to conduct current. Usually the carbon black particles are dispersed in polyolefin-based granulates (PP, LD/HD-PE) in amounts between 5 and 25 wt %, in each case according to the grade and type of carbon black. Injection-molded and extruded articles of all kinds can be made from these compounds. Film grades can also be obtained, but they require a higher expenditure for dispersion. The conductive effect is obtained immediately, independent of atmospheric humidity, it is not limited in time and is suitable both for mass [applications] and for high-tech applications.

Compared to other variations, conductive blacks have a lower purchase price, offer a very long lifetime for conductive finishing and can be easily processed by conventional techniques.

However, the conductivity is highly dependent on the carbon black concentration in the end product. A percolation behavior is therefore observed. Depending on the mixture ratios and processing condition, there is a narrow region where the conductivity increases or decreases sharply with small changes of the concentration of the conductive black.

A major disadvantage is that these materials cannot be dyed and for the most part exist only in black color. Some mechanical products may be degraded by the high addition of conductive black. The conductivity of these materials also changes upon mechanical stress, strain or stretching. With that, specific conductivity values cannot always be guaranteed over the duration of the load in the case of stretched fiber and film applications.

The latest developments in the field of high-performance antistatics and conductive additives are based on nanoscale metal oxides of indium, tin, antimony or zirconium, and also on single/multiwall carbon nanotubes (SWCNT and MWCNT).

Generally speaking, all of these new materials must be present as nanoparticles in the end product in concentrations that are as low as possible, or they might not develop the expected effect that would also justify the high purchase price. One should also take into account that the polarity of the plastic carrier plays an important role. In polar plastics like PC, PA and PBT, the results are clearly better than in nonpolar PP. However, broad mass application lies in conductive PP and HDPE articles, which explains the current lack of commercial penetration of the nanotubes.

The situation is similar with intrinsically conductive materials (ICP) like polyanilines, polythiophenes, etc., which also guarantee a long-lasting conductive effect. They give the end product a dark color (green, gray, brown), which cannot be masked by other colors. Moreover, these ICP particles are very sensitive to shear. Accordingly, their effect can be nullified due to machine processing conditions, since they experience mechanical damage due to shear in the extruder itself. ICPs, like carbon black materials, produce long-lasting conductive properties. The purchase price is still greater than that of the commercially available conductive blacks.

Of all of the commercially available (volume-active) conductive products, polymer systems based on polyamide-polyether block amides (adipic acid caprolactam-polyether glycol copolymers) currently represent the best technical solution. A static dissipation (conductive) effect (around 10⁷Ω), both at the surface and in the volume of a thick-walled plastic object, can be generated independent of the ambient atmospheric humidity. This plastic article can also be dyed without a loss of conductivity. However, there are some disadvantages that necessitate a search for other alternative products. Applications in PP and PC/ABS are known, but are problematic with other plastics (PA, EVA).

The material costs per kg of modified article are elevated due to the high additions of about 10-15 wt %, in order to be able to generate the desired antistatic effect. These high amounts of added material are at times the cause of a deterioration of some mechanical properties in the end products.

The reinforcement of thin-walled articles with these PA-polyether copolymers is not carried out because of the resulting insufficient quality. Fiber applications are also not a possibility because of the lack of mechanical strength and the high added concentrations.

Organic substances (internal antistatics) that can exert a surface-active effect (“surfactants”) are listed below:

N-containing fatty derivatives like primary, secondary and tertiary amines, alkyldiamines, quaternary ammonium compounds, ethoxylated quaternary ammonium compounds, ethoxylated alkylamines, ethoxylated alkyldiamines, alkylaminoacetates, diaminodiacetates, alkylaminooxides, aliphatic amides, ethoxylated alkylamides, organic molecules with heteroatoms like alkyl sulfonates and fatty acid polyesters (for example glycerol monostearate), and in general anionic and nonionic surfactants.

The effect of these internal antistatics is based on the migration of the active substances from the polymer matrix because of the different polarities of the polymer (low) and the antistatic (high).

These surfactants are usually characterized by a long-chain hydrophobic alkyl group and a hydrophilic component formed around a heteroatom.

These hydrophilic and hydrophobic components line up differently depending on ambient conditions.

The polar hydrophilic chemical groups of the antistatics become outwardly oriented at the plastic/ambient air interface with time and dependent on the ambient air humidity, while the nonpolar, lipophilic, as a rule long-chain, hydrocarbon-containing groups position themselves toward the interior of the plastic.

At the polymer/air interface, the hydrophilic groups project from the surface and attract moisture from the surroundings, while the hydrophobic alkyl chain points inward. Due to the attraction of moisture at the surface, electrons can more easily be transported by the dissociated ions that are present, i.e., the electrical resistance becomes smaller.

A mixture of plastic, lithium nitrate and an antistatic is disclosed in U.S. Pat. No. 4,746,697 A. The use of lithium nitrate instead of lithium chloride is recommended for better dispersion. In addition, it is pointed out how the salt (lithium nitrate or lithium chloride) should be predispersed. This involves dissolving the salt in water before it comes into contact with the antistatic in molten state, immediately before being sent to the extruder. This is said to improve dispersion of the salt during the extrusion and in the end product (film).

An antistatic mixture of fatty acid dialkyl amides with inorganic salts is disclosed in GB Patent No. 1 118 324 A. Bringing the carrier material (plastic) into contact with a premade solution of the active materials (salt and antistatic substance) in a solvent, which is not disclosed in more detail, is proposed as an especially good method for improving the dispersion of the salt with the antistatic organic substance. The solvent was to be removed in a subsequent extrusion process, and the dispersion was expected to be better.

The invention is based on the task of specifying a possibility for producing a plastic granulate through which a thermoplastic product that has a maximum specific surface resistance of 10⁸Ω can be produced without using metal fibers, metal oxides, graphite, conductive black, intrinsically conductive polymers, single/multiwall carbon nanotubes, organically modified nanoclays or polyamide-polyether block amides (more precisely: those based on adipic acid-caprolactam-polyether glycol copolymers and related substances), where the plastic granulate is characterized by better dispersion of the active substances contained in it.

In accordance with the invention, the problem is solved in an extrusion process for producing a plastic granulate, in that first in a preliminary step a mixture of lithium chloride and anticaking agents from the group of chalk, talcum, silica, titanium dioxide, zinc sulfide, barium sulfate and aluminum oxide is ground to a particle size d90=20 μm, and then the starting substances

a) at least one organic surface-active internal antistatic,

b) a thermoplastic plastic and

c) the mixture

prepared in pure form, individually or as a mixture, in order to be sent directly to the extrusion machine at the same time, in succession, or separate from each other, via the same or different gravimetric or volumetric dispensing devices, at a processing temperature in the heating zones of the extrusion machine that is preset depending on the thermoplastic, and the resulting polymer melt is either cooled in strand form and granulated via a water bath operated at normal ambient pressure, or is prepared as lens-shaped, spherical or ellipsoidal granulate without cut edges via an underwater granulation system operated under pressure and connected directly and immediately to the head of the extruder end. The mixture of lithium chloride and anticaking agents is advantageously prepared in ratios of 90 wt % to 10 wt %. It likewise proves to be favorable if the anticaking agent is prepared from chalk and silica in an equal ratio.

The invention will now be explained in more detail by means of embodiment examples. These are exemplary recipes for masterbatches and compounds.

Masterbatch 1 (MB1).

A masterbatch granulate is prepared using the following recipe:

5 wt % glycerol monostearate

5 wt % ethoxylated alkylamine (alkyl chain length of C13-C15)

5 wt % lithium chloride

0.25 wt % chalk

0.25 wt % silica

85 wt % PP

Compound 1 (C1)

A compound granulate is made using the following recipe:

0.5 wt % glycerol monostearate

0.5 wt % ethoxylated alkylamine (alkyl chain length of C13-C15)

0.5 wt % lithium chloride

0.025 wt % chalk

0.025 wt % silica

98.45 wt % PP

Both in making the masterbatch and making the compound the mixture of lithium chloride, chalk and silica is first ground to a particle size d90=20 μm in a preliminary step.

The invention is carried out using a single- or twin-screw extruder, ring extruder or horizontally oscillating colcneader for industrial extrusion processing of the starting substances into a homogeneous blend in granulate form.

The use of gravimetric or volumetric dispensing devices, through which all of the starting substances are dispensed into the extruder screw at the same time or in succession, is easily possible.

By setting a processing temperature that is dependent on the carrier material at the extruder or the kneader, the preliminary mixture is melted and extruded. This melt can be either cooled in the form of a solid strand under normal ambient conditions by means of a water bath and chopped into cylinder form via a granulator, or first cooled at the extruder head under a closed, pressurized underwater granulation system and shaped as lens-shaped, ellipsoidal or spherical granulate.

To produce injected-molded objects, extruded goods, panels, films, spinnable and tape fibers, one takes either the masterbatch MB1 and dispenses it in the amount of 1-10 wt % into a suitable PP carrier or compound C1, and adds it either undiluted or together with additional substances (additives, dye masterbatches) to the extruder, kneader or injection molding machine.

In addition, if desired it is also possible to add a phosphidic and/or phenolic thermal stabilizer and/or an antioxidant to protect against heat-related decomposition reactions of the carrier material or decomposition reactions caused by the chemical effect of oxygen or radicals.

The use of these granulates is expressly indicated for statically dissipative/conductive reinforcement of thin- and thick-walled, dyed or undyed, unreinforced or mechanically reinforced articles such as injection-molded and extruded goods, films, networks, panels, fibers and filaments.

1. An extrusion process for making a plastic granulate consisting of the following steps: in a preliminary step, a mixture of lithium chloride and anticaking agents from the group of chalk, talcum, silica, titanium dioxide, zinc sulfide, barium sulfate and aluminum oxide is ground to a particle size of d90=20 μm, then the starting substances a) at least one organic surface-active internal antistatic, b) a thermoplastic plastic and c) the mixture are prepared in pure form, individually or as a mixture, in order then to be sent directly to the extrusion machine at the same time, in succession or separately from each other via the same or different gravimetric or volumetric dispensing devices at a processing temperature of the heating zones of the extrusion machine that is preset depending on the thermoplastic, and the resulting polymer melt is either cooled and granulated in strand form via a water bath operated at normal ambient pressure or is prepared as lens-shaped, spherical or ellipsoidal granulate without cut edges via an underwater granulation system operating under pressure and connected directly and immediately to the end of the extruder head.

2. An extrusion process as in claim 1, characterized in that the mixture of lithium chloride and anticaking agents is prepared in a ratio of 90 wt % to 10 wt %.

3. An extrusion process as in claims 1 and 2, characterized in that the anticaking agent is prepared from chalk and silica in the same proportion.
